(19) United States
(12) Patent Application Publication
(10) Pub. No.: US 2008/0287283 A1
(43) Pub. Date: Nov. 20, 2008

(54) Catalyst body and methods

(76) Inventors: Patrick David Tepesch, Corning, NY (US); Raja Rao Wusirika, Painted Post, NY (US)

Correspondence Address: CORNING INCORPORATED, SP-TI-3-1, CORNING, NY, 14831, US

(21) Appl. No.: 12/150,490

(22) Filed: Apr. 29, 2008

Related U.S. Application Data
(60) Provisional application No. 60/930,239, filed on May 15, 2007.

(51) Int. Cl. B01J 29/04

(52) U.S. Cl. 502/62

(57) ABSTRACT

Disclosed are a catalyst and a catalyst body as defined herein and methods of use and manufacture.

### CLAIMING BENEFIT OF PRIOR FILED U.S. APPLICATION

This application claims the benefit of U.S. Provisional Application Ser. No. 60/930,239, filed on May 15, 2007. The content of this document and the entire disclosure of publications, patents, and patent documents mentioned herein are incorporated by reference.

### BACKGROUND

The disclosure relates to a catalyst that breaks down nitrogen oxides in the presence of a reducing agent, and particularly to ammonia selective catalytic reduction of nitrogen oxides in automotive applications.

Nitrogen oxides, such as nitrogen monoxide (NO) and nitrous oxide (NO₂), are air pollutants and pose environmental challenges. Nitrogen oxides have been implicated in acid rain and smog formation. Nitrous oxide is a greenhouse gas and may contribute to the destruction of atmospheric ozone. Reducing nitrogen oxides has become a matter of urgent environmental concern.

Emissions from automobile and truck exhaust are major contributors of atmospheric nitrogen oxides. Exhaust gas discharged from internal combustion engines contains pollutants such as nitrogen oxides, carbon monoxide, and hydrocarbons. These pollutants may be removed from the exhaust gas by passing the exhaust gas over a catalyst supported on a carrier material. Catalysts may include precious metals, such as, platinum, rhodium, and palladium. Catalyst supports are often ceramic honeycomb structures. Nitrogen oxides are reduced to nitrogen and oxygen. Carbon monoxide and hydrocarbons are oxidized to carbon dioxide and water. The level of oxygen in the exhaust gas can influence the catalyst performance. For example, a high partial pressure of oxygen can limit reduction of nitrogen oxides while a low partial pressure can inhibit the oxidation of carbon monoxide and hydrocarbons.

In the case of an exhaust gas discharged from diesel engines, however, such precious metal catalysts may be ineffective for removing nitrogen oxides because of the large amount of oxygen in the exhaust gas. The same problem occurs in “lean-burn” gasoline engines were oxygen levels in the exhaust gas are elevated.

One technology that has been used to remove nitrogen oxides includes an absorber combined with cycling the engine between lean-burn and rich-burn conditions. The absorber comprises a ceramic honeycomb, precious metal catalysts, and base metal oxides. In lean-burn conditions, nitrogen oxides are oxidized and adsorbed by the catalyst. The base metal oxide converts the nitrogen oxide to a solid nitrate. In rich-burn conditions, the exhaust gas reduces the nitrates to nitrogen and regenerates the absorber. Absorbers using this cycling process can reduce emissions of nitrogen oxides, but the rich-burn cycle adversely affects drivability and subjects the engine to a fuel penalty. Further, absorbers are contaminated by residual sulfur compounds that are present in the fuel and exhaust gas.

An alternative technology is the selective catalytic reduction (SCR) process. SCR uses a zeolite material coated with a suitable catalyst. Exhaust gas including nitrogen oxides passes over and through the zeolite, and is converted into nitrogen and water. Typically, zeolites comprise particles that exhibit a regular array of accessible micropores. The micropores are produced by the crystalline structure of the material. The zeolite is impregnated with a catalyst to form a catalyst body. Suitable catalysts include a transition metal oxide, such as oxides of iron, or a lanthanide series metal oxide. The catalyst body is suitable for breaking down the nitrogen oxides using the selective catalytic reduction process, for example, at from about 200 to 700° C. Unlike absorbers, zeolite catalyst bodies require no lean-rich cycling of the exhaust gas.

The metal oxide is commonly applied to the zeolite as a metal salt compound in an aqueous solution. The zeolite is calcined, that is, heated to a temperature below its melting or fusing point but sufficient to cause loss of moisture, reduction or oxidation, and the decomposition of the salt and other compounds. Calcination often produces noxious volatiles such as sulfates or nitrates as a result of decomposition of the corresponding sulfate or nitrate salt. Calcining activates the metal ion in the zeolite to produce the active catalyst. The catalyst may then be applied to a support, such as, a cordierite honeycomb, to produce the supported catalyst body. Iron salts with the iron in the +2 oxidation state have produced superior catalysts when compared to the iron in the +3 oxidation state. Unfortunately, iron in the +2 oxidation state is generally unstable in an atmosphere containing oxygen and typically oxidizes to the +3 state. Solutions of ferrous salts have proven to be more effective precursors than solutions of ferric salts. Common iron salts include ferrous ammonium sulfate and ferric nitrate. Unfortunately, ferrous compounds in the +2 oxidation state readily oxidize in air to the ferric +3 oxidation state. The instability of ferrous salts has made the production of the SCR catalyst body more difficult.

### SUMMARY

The disclosure generally relates to a metal oxide catalyst composition, and to methods for making bodies that include the catalyst and use of the bodies to form useful articles, for example, selective catalytic reduction (SCR) articles or devices.

The disclosure provides a metal oxide catalyst composition useful in, for example, ammonia SCR. The metal oxide catalyst can be prepared by applying a suitable metal (II) salt such as iron (+2) to, for example, a zeolite article or an alternative molecular sieve article, and then calcining to produce the catalyst. The catalyst can be combined with a suitable ceramic body to provide the useful article.

The disclosure provides a metal-molecular sieve catalyst for use in selective catalytic reduction of nitrogen oxides. The catalyst can be made by a process comprising, for example: preparing a mixture of molecular sieve and a compound of the formula MRₙ, and calcining the mixture. In the compound of the formula MRₙ, M comprises a metal having a +2 oxidation state; R comprises an organic ligand comprising at least one substituent which coordinates with the metal ion to form the metal ligand compound and the substituent includes an electronegative moiety; and n is an integer from 1 to 4.

### BRIEF DESCRIPTION OF THE DRAWINGS

FIG. 1 is a graph of percent NOₓ conversion versus temperature for a catalyst body compared to two bodies prepared from commercial precursors, in embodiments of the disclosure.

FIG. 2 is a graph of percent NOₓ conversion versus temperature for a disclosed catalyst body compared to a body prepared from ferrous ammonium sulfate, in embodiments of the disclosure.

FIG. 3 is a graph of percent NOₓ conversion versus temperature for a catalyst body in embodiments of the disclosure.

FIG. 4 is a graph of percent NOₓ conversion versus temperature for a catalyst body prepared from a ferrous gluconate precursor on two zeolites having different silica to alumina ratios, in embodiments of the disclosure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In embodiments, the disclosure provides a compound of the general formula MRₙ as defined herein. The compound of the formula MRₙ provides a useful intermediate or precursor to a metal-molecular sieve combination for use in SCR. A molecular sieve is a material containing tiny pores of a substantially uniform size that can be used as an absorbent substrate for gases and liquids for catalytic applications and may include, for example, a zeolite. Zeolites are crystalline solids having a structure defining a plurality of micropores. Zeolites generally include a framework of silicon, aluminum, and oxygen that defines the micropores. The micropores readily accept cations such as metal ions.

The compound of the formula MRₙ includes a metal salt comprising a metal ion in the +2 oxidation state which is chelated with an organic ligand R. The metal can be, for example, selected from the group consisting of a transition metal, such as iron, or a lanthanide series element or combinations thereof. The organic ligand includes a structure as defined herein and like structures which are capable of chelating, coordinating, or otherwise complexing with the metal ion. A single organic ligand or molecule, or a plurality of organic ligands molecules may chelate a single metal ion. The organic ligand can include, for example, an electronegative moiety or a high electronegativity moiety such as carboxyl, alkoxy, hydroxyl, halogen, or like substituents, and combinations thereof. The substituent(s) can function, for example, as a metal chelator to bind the ligand to the metal. The substituents can also function, for example, as a non-chelate group to, for example, manipulate the properties of the ligand or the resulting complex, such as stability, solubility, handling, or like properties of the chelated complex. A metal in the +2 oxidation state may chelate with up to four moieties. Certain ligands such as bi-dentate ligands can complex or chelate with the metal ion to form a ring structure, such as five- or six-membered rings. Chelation and the reducing power of the ligand retards oxidation of the metal from the +2 oxidation state to the +3 oxidation state.

In embodiments, a metal (II) compound or complex of the disclosure, such as iron (II) gluconate, can produce a catalyst body that is superior to those produced from metal (III) complex compound, and at least equal to those metal complex compounds produced from known metal (II) complex compounds such as ferrous chloride and ferrous ammonium sulfate. In embodiments, the metal (II) compound or complex of the disclosure is readily soluble in water to facilitate manufacture, such as dissolution, mixing, pumping, washing, coating, or like operations or handling, and emits little or no harmful volatiles during calcination.

In embodiments, suitable metal ligands (R) can be, for example, bi-dentate or poly-dentate and can include, for example, fumarate, citrate, oxalate, lactate, gluconate, and ethylene-diamine-tetra-acetate (EDTA). Table 1 shows the solubility in water of ferrous salts of these ligands

TABLE 1

| | Ferrous salt solubility |
|---|---|
| Ligand | (g in 100 g water at 25° C.) |
| Fumarate | Negligible |
| Citrate | <5 |
| Ammonium oxalate | 10 |
| Lactate | 5 |
| Gluconate | 20 |

Ammonium ethylene-diamine-tetra-acetate (EDTA) of Fe (+2) has good solubility, but can be costly and may also form ammonia during calcination.

In embodiments, the metal (II) compound or complex of the disclosure can comprise an organic ligand and a metal ion in the +2 oxidation state. The organic ligand chelates with the metal (II) ion to stabilize the ion from further oxidation. Calcination can decompose the organic ligand substantially or entirely into innocuous fugitive gases.

In embodiments, the precursor can include an organic ferrous complex or compound, and salts thereof. The ferrous ion can be chelated with one or more certain organic ligands so that the ferrous ion resists further oxidation. The organic ligand includes at least one electronegative moiety which can optionally chelate with the iron (II) ion, such as a carboxyl, a hydroxyl, or like groups, and combinations thereof. The organic portion can comprise, for example, a substituted or unsubstituted alkyl or alkylene having at least one substituent that can chelate with the metal (II) ion. An alkyl ligand, for example for a mono-dentate ligand, can be a monovalent hydrocarbyl group including a saturated or unsaturated (C₁-C₂₀)alkyl-. An alkylene ligand can be, for example, divalent hydrocarbyl group including a saturated or unsaturated alkylene, including a saturated or unsaturated (C₁-C₂₀)alkylene.

Each monovalent, divalent, trivalent, tetravalent, or like valent R group can independently be a branched or unbranched, saturated or unsaturated group.

In embodiments, halo or halide substituents include fluoro, chloro, bromo, or iodo. Alkyl, alkoxy, etc., include both straight and branched groups.

“Alkyl” includes linear alkyls, branched alkyls, and cycloalkyls.

“Substituted alkyl” or “optionally substituted alkyl” refers to an alkyl substituent, which includes linear alkyls, branched alkyls, and cycloalkyls, having from 1 to 4 optional substituents selected from, for example, hydroxyl (—OH), halogen, amino (—NH₂), nitro (—NO₂), alkyl, acyl (—C(═O)R′), alkylsulfonyl (—S(═O)₂R′) or alkoxy (—OR′). For example, an alkoxy substituted alkyl, can be a 2-methoxy substituted ethyl of the formula —CH₂—CH₂—O—CH₃, a 1-dialkylamino substituted ethyl of the formula —CH₂(NR₁₂)—CH₃, and like substituted alkyl substituents, where R′ can be H or alkyl.

The carbon atom content of various hydrocarbon-containing moieties is indicated by a prefix designating a lower and upper number of carbon atoms in the moiety, i.e., the prefix Cᵢ₋ⱼ indicates a moiety of the integer “i” to the integer “j” carbon atoms, inclusive. Thus, for example, (C₁-C₁₀)alkyl or C₁₋₁₀ alkyl refers to alkyl of one to ten carbon atoms, inclusive, and (C₁-C₄)alkyl or C₁₋₄ alkyl refers to alkyl of one to four carbon atoms, inclusive.

The compounds of the present disclosure are generally named according to the IUPAC nomenclature system. Abbreviations, which are well known to one of ordinary skill in the art, may be used (e.g., “Ph” for phenyl, “Me” for methyl, “Et” for ethyl, “h” for hour or hours, “g” or “gm” for gram(s), “mL” for milliliters, and “rt” for room temperature).

“Include,” “includes,” or like terms means including but not limited to.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates, use formulations or articles; through inadvertent error in these procedures; through differences in the manufacture, source, or purity of starting materials or ingredients used to carry out the methods; and like considerations. The term “about” also encompasses amounts that differ due to for example aging of a formulation with a particular initial concentration or mixture, and amounts that differ due to mixing or processing a formulation with a particular initial concentration or mixture. Whether modified by the term “about” the claims appended hereto include equivalents to these quantities.

“Consisting essentially of” in embodiments refers, for example, to a single compound, mixture of compounds, or a composition, the method of using a compound or composition to make metal oxide catalyst containing body, and articles or devices of the disclosure, and can include the components or steps listed in the claim, plus other components or steps that do not materially affect the basic and novel properties of the compounds, composition, articles, and methods of use of the disclosure, such as the particular supports, the particular metal (II) complex compound, the particular metal oxide or mixed metal oxide, or like structure, material, or process variables selected. Items that may materially affect the basic properties of the components or steps of disclosure or may impart undesirable characteristics to the present disclosure include, for example, decreased or loss of catalytic activity of the M-zeolite complex, decreased burn-off, and like performance characteristics. In embodiments, the compounds, the composition, the articles or devices, or the methods of the present disclosure preferably eliminate or avoid such undesirable characteristics. Thus, the claimed invention may suitably comprise, consist of, or consist essentially of: a compound of the formula MRₙ as defined herein in combination with a suitable substrate such as a zeolite or like molecular sieve; a composition of the reaction product including a compound of formula MRₙ, as defined herein with a suitable substrate and in combination with a suitable ceramic carrier body or like material; or a method of making the catalytic ceramic carrier body as defined herein.

The indefinite article “a” or “an” and its corresponding definite article “the” as used herein means at least one, or one or more, unless specified otherwise.

Specific and preferred values listed below for radicals, substituents, and ranges, are for illustration only; they do not exclude other defined values or other values within defined ranges for the radicals and substituents. The compounds of the disclosure include compounds of formula MRₙ and like compounds having any combination of the values, specific values, more specific values, and preferred values described herein.

Specifically, C₁₋₄ alkyl can be methyl, ethyl, propyl, isopropyl, butyl, iso-butyl, sec-butyl, tert-butyl; C₁₋₇ alkyl can be methyl, ethyl, propyl, isopropyl, butyl, iso-butyl, sec-butyl, tert-butyl, pentyl, 3-pentyl, hexyl, or heptyl; (C₃₋₁₂)cycloalkyl can be cyclopropyl, cyclobutyl, cyclopentyl, cyclohexyl, cycloheptyl, cyclooctyl, bicyclic, or multi-cyclic substituents. C₁₋₄ alkoxy can be methoxy, ethoxy, propoxy, isopropoxy, butoxy, iso-butoxy, or sec-butoxy; —C(═O)alkyl or (C₂₋₇)alkanoyl can be acetyl, propanoyl, butanoyl, pentanoyl, 4-methylpentanoyl, hexanoyl, or heptanoyl; aryl (Ar) can be phenyl, naphthyl, anthracenyl, phenanthrenyl, fluorenyl, tetrahydronaphthyl, or indanyl; Het can be pyrrolidinyl, piperidinyl, morpholinyl, thiomorpholinyl, or heteroaryl; and heteroaryl can be furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl (or its N-oxide), thienyl, pyrimidinyl (or its N-oxide), indolyl, isoquinolyl (or its N-oxide) or quinolyl (or its N-oxide).

Specifically, —(CH₂)ₖ— can be a —(C₁₋₂₀ alkylene)- when k is an integer from 1 to about 20, which can be methylenyl, ethylenyl, propylenyl, butylenyl, pentylenyl, 3-pentylenyl, hexylenyl, heptylenyl, octylenyl, nonylenyl, decylenyl, and like unsubstituted or substituted homologs.

Specifically, —(CH₂)ₖ— can be a —(C₁₋₇ alkylene)- when k is an integer from 1 to about 7, or from 1 to about 5, which can be methylenyl, ethylenyl, propylenyl, butylenyl, pentylenyl, 3-pentylenyl, hexylenyl, or heptylenyl.

Specifically, —(CH₂)ₖ— can be a —(C₁₋₄ alkylene)- when k is an integer from 1 to about 4, which can be methylenyl, ethylenyl, propylenyl, or butylenyl.

A specific compound of the formula MRₙ is where M is Fe(+2) and R can be, for example, (C₁-C₄)alkyl having at least one coordinating substituent, such as a carboxy (—CO₂H), hydroxyl (—OH), or both, and n is from 1 to 4, for example, CH₃—CH₂—CH(O⁻)—C(═O)—O⁻.

Another specific compound of the formula MRₙ is where M is Fe(+2) and R can be, for example, —CH₂—CH₂—, or a (C₁-C₄)alkyl substituted —CH₂—CH₂— having at least one coordinating substituent, such as a carboxy and a hydroxyl group, and n is from 1 to 4, for example, ⁻O—CHR′—C(═O)—O⁻ where R′ can be monovalent (C₁-C₄)alkyl or a substituted (C₁-C₄)alkyl.

Another specific compound of the formula MRₙ is where M is Fe(+2) and R can be, for example, —CH₂—Ar—CH₂—, or (C₁-C₄)alkyl substituted —CH₂—Ar—CH₂—, where Ar can be, for example, an ortho-, meta-, or para-substituted-C₆H₄—; such as ortho-CH₂—C₆H₄—CH₂—, or (C₁-C₄)alkyl substituted —CH₂—Ar—CH₂—, such as —CH₂—C₆H₃(R′)—CH₂—, or optionally alkyl substituted —CH₂—C₆H₄—CH(R′)—, where R′ can be (C₁-C₄)alkyl or a substituted (C₁-C₄)alkyl, and each R having at least one coordinating substituent, such as a carboxy, hydroxyl, or both, and n is from 1 to 4.

Another specific compound of the formula MRₙ is where M is Fe(+2) and R can be, for example, a divalent saturated or unsaturated —(C₂-C₆)alkylene-, —Ar—, or (C₁-C₄)alkyl substituted —Ar—, and each R having at least one coordinating substituent, such as a carboxy, hydroxyl, or both, and n is from 1 to 4, for example, HO—C(═O)—CH(OH)—CH(O⁻)—C(═O)—O⁻, 1,2-dihydroxy-phenyl, 3-(C₁-C₄)alkyl substituted 1,2-dihydroxy-phenyl, and like compounds.

An example of a class of suitable organic ligands for R includes carbohydrate acids, such as gluconic acid.

A specific compound of the formula MRₙ is, for example,

M(II)(alpha-hydroxy alkyl carboxylate)₂

Another specific compound of the disclosure incorporates one or more mono- or bi-dentate ligands and a coordinating metal such as Fe(II), for example of the formula below and permutations thereof.

Fe(II)(—O(C═O)—CH(O—)—CH₂—CH₂—CH₃)₂

Another specific compound of the disclosure incorporates mixed bi-dentate ligands and a coordinating metal such as Fe(II), for example of the formula below and permutations thereof.

Fe(II)(—O(C═O)—CH(O—)—CH₂—CH₂—CH₃)(oxalate)

where oxalate is of the formula ⁻O(C═O)—C(═O)O⁻ or {⁻O(C═O)—}₂.

Another specific compound of the disclosure incorporates a mixed bi-dentate ligand and mono-dentate ligands and a coordinating metal such as Fe(II), for example of the formula below and permutations thereof.

Fe(II)(—O(C═O)—CH(O—)—CH₂—CH₂—CH₃)(OAc)₂

where OAc is an acetate or —O(C═O)—CH₃.

Another specific compound of the disclosure incorporates one or more mono- or bi-dentate ligands and a coordinating metal such as Fe(II), for example of the formula below and permutations thereof.

Fe(II)(gluconate)₂ or Fe(II)bis-gluconate

Another specific compound of the disclosure incorporates one or more mono- or bi-dentate ligands and a coordinating metal such as Fe(II), for example of the formula

Fe(II)(carbohydrate acid)₂

In embodiments, the compound of the formula MRₙ can be, for example, ferrous gluconate, having two gluconic acid molecules chelated to the ferrous ion. The chelated ferrous ion resists oxidation to the ferric ion. In preparative processes of the disclosure, ferrous gluconate can be, for example, dissolved in water and applied to a zeolite by any suitable method including incipient wetting, slurry, or like methods, and combinations thereof. Although not desired to be limited by theory, calcining of the mixture is believed to bond the residual metal ion catalyst to the zeolite or molecular sieve to produce a M-zeolite or M-molecular sieve, and oxidizes the organic ligand, such as the carbohydrate acid, to carbon dioxide and water.

The M-molecular sieve or M-zeolite material can be applied to a suitable support, for example, as a wash coat to form a catalyst body. A common support includes a refractory ceramic honeycomb such as cordierite. Alternatively, a spray dried M-zeolite or M-molecular sieve may be mixed with a refractory ceramic and extruded to form a porous article. The article can be fired to produce the catalyst body.

In embodiments, the organic ligand can comprise the anion of an organic acid including carbohydrate acids, such as lactic acid (2-hydroxypropanoic acid), gluconic acid, or combinations thereof. Carbohydrate acids include a carboxyl group and at least one hydroxyl group along a carbon backbone. In embodiments, the carbohydrate acid can include a carboxyl group and having a hydroxyl group at least one or two carbon atoms removed from the carboxyl group. The carboxyl group is preferably a terminal or primary carboxyl group to facilitate complexation with the metal ion; although other carboxyl group locations are possible and commercially available. In embodiments, the carbon backbone permits both the carboxyl and hydroxyl groups of a single ligand to chelate the metal (II) ion. Terminal carboxyl groups on the ends of the molecule or two carboxyl groups situated elsewhere within carbon backbone can afford a bi-dentate ligand which can chelate the metal (II) ion. In embodiments the organic ligands R of the formula MRₙ can be, for example, the same or different, such as, M(gluconate)₂ or M(gluconate)(malonate), M(glucoheptanate), or like same or mixed ligands. In embodiments, the MRₙ compound can be comprised of a mixture of suitable metal (+2) salts, for example, Fe(gluconate)₂ or Cu(gluconate)₂.

By way of example, gluconic acid is the carboxylic acid formed by the oxidation of the first carbon of glucose and has the chemical formula C₆H₁₂O₇. When dissolved in water, it forms the gluconate ion C₆H₁₁O₇⁻. Salts of gluconic acid are also known as gluconates. Two molecules of gluconate chelate a ferrous (Fe⁺²) ion to form a ferrous gluconate salt of the formula:

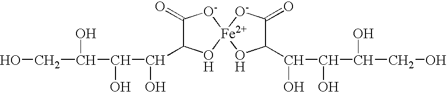

The chelated metal (II) ion can be applied to a molecular sieve, such as a zeolite or like support, by any suitable technique including, for example, incipient wetting, slurry, or like methods. The molecular sieve can include, for example, H⁺, NH₄⁺, Na⁺, and like forms, and mixtures thereof. Incipient wetting involves carefully exposing the molecular sieve or zeolite to a solution of the metal (II) salt that is just sufficient to thoroughly wet the solid and fill the pore volume. A slurry technique includes adding an excess amount of a metal (II) complex solution to the zeolite support and drying the mixture until at least superficially dry. In embodiments, the MRₙ compound can be formed in situ, for example, including in a mixture of a suitable metal(+2) salt or metal(+2) salts and appropriate quantities of the organic ligand n(R) sufficient to form the MRₙ compound, along with the molecular sieve and optionally the refractory ceramic material prior to extruding, drying, or firing.

After application of the chelated metal ion, the treated zeolite support is calcined to remove excess water, burn off the organic portion of the ligand(s), and to bind the metal to the zeolite, to form an M-zeolite material. Calcining typically occurs at temperatures above about 300° C. In embodiments, the organic portion of the metal (II) salt oxidizes to form carbon dioxide and water. Related metal (II) complexes, such as sulfate and nitrate salts, may produce noxious and hazardous volatiles during calcining.

The M-zeolite or M-molecular sieve material can be applied as a wash coat to a suitable support to form the catalyst body. Supports can include, for example, porous refractory articles with low coefficients of thermal expansion (CTE), that is, a CTE less than about 15×10⁻⁷ from about 100 to about 500° C. Porosity increases the available surface area for reaction. Refractoriness is necessary to resist operating temperatures that can exceed 500° C. A low CTE allows the catalyst body to resist thermal shock, that is, cycling between about 25° C. and about 500° C. Articles may comprise refractory compounds, for example, refractory ceramic articles including metal oxides and spinels such as alumina, cordierite, and silica. Cordierite honeycombs are common supports for SCR bodies. Cordierite is a refractory ceramic with a low CTE.

Alternatively or in addition to a washcoat, the M-zeolite material or M-molecular sieve can be spray dried and mixed with the refractory compound before calcining. The M-zeolite-refractory compound or M-molecular sieve-refractory compound may be extruded to form a honeycomb structure and fired to create the catalyst body.

### EXAMPLES

Embodiments of the disclosure are further illustrated with reference to the examples and as summarized in the accompanying tables or figures, if any. Compositions or mixtures of materials that mention percents or parts refer to weight percents or parts-by-weight unless specifically indicated otherwise. The compositions of the fired examples have been estimated.

### Example 1

Several iron-zeolite SCR powders were produced using saturated solutions of iron salts and the incipient wetting technique. The zeolite was a ZSM-5 type with silica/alumina ratios of 60:1 and 25:1. ZSM-5 is a common zeolite in automotive applications. The iron (II) compound selected was ferrous gluconate, which was compared to similar samples prepared with ferrous ammonium sulfate and ferric nitrate. After wetting, the iron-zeolite was dried at 100° C. and then calcined at 550° C. to form the catalyst. The final concentration of iron in the catalyst was about 4 wt. %. A wash coat was made with a 1:1 mixture of water and the catalyst, and was applied on cordierite honeycombs. The viscosity of the wash coat should be low enough to permit thorough wetting of the honeycomb. The ratio of catalyst to water is not critical. Optionally, the wash coat may include a binder, such as methylcellulose or an aluminate. The nitrogen oxide SCR conversion activity was measured and plotted as described below.

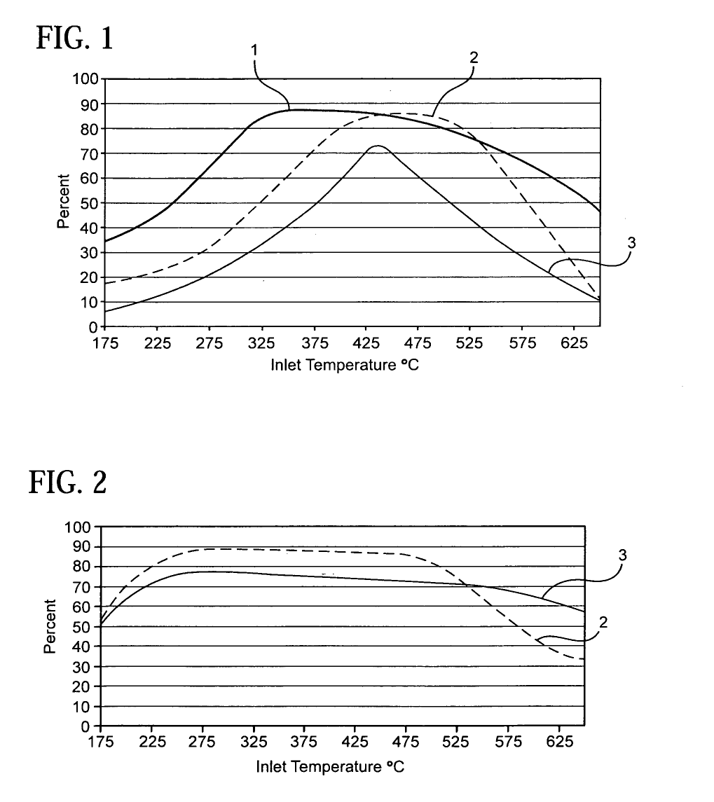

FIG. 1 graphs the percent of nitrogen oxides that were converted to nitrogen and oxygen at temperatures from about 175 to about 650° C. for the three iron compounds. The exhaust gas temperature of a diesel engine is often above about 500° C. Low temperatures on the graph correspond to periods when the engine has just started and the cordierite honeycomb has not yet heated up. Conversion data for temperatures above about 500° C. corresponds to typical operating temperatures.

The iron (Fe⁺³) nitrate of curve 3 showed the poorest conversion across the entire temperature range. The ferrous (Fe⁺²) ammonium sulfate of curve 2 had conversions consistently about 10-20% greater than iron nitrate at any temperature. Ferrous (Fe⁺²) gluconate of curve 1 was superior to ferrous ammonium sulfate. The light-off temperature, that is, the temperature at which conversion exceeds a predefined benchmark or target, was best for ferrous gluconate. Ferrous gluconate attained about 70% conversion about 100° C. lower than ferrous ammonium sulfate and 150° C. lower than ferric nitrate. Furthermore, the conversion curve of ferrous gluconate was flatter or more constant across the entire temperature range. Conversion with ferrous gluconate remained above about 40% even at 650° C. while the others dropped below about 20%.

Without intending to be bound by theory, its believed that unchelated inorganic ferrous salts are prone to oxidation to the ferric ion, and a significant amount of ferrous ions convert to ferric ions so that the SCR catalyst made from the ferrous ammonium sulfate precursor begins to emulate the SCR catalyst made from the ferric nitrate precursor. In contrast, we believe that ferrous gluconate is chelated and is stabilized in the ferrous state. The shape of the ferrous ammonium sulfate curve is intermediate between the ferrous gluconate curve and the ferric nitrate curve. This interpretation is consistent with x-ray fluorescence data that showed increasing amounts of iron (III) oxide outside the Fe-zeolite when comparing products made of ferrous gluconate, ferrous ammonium sulfate, and ferric nitrate compounds.

### Example 2

Two iron-β zeolite SCR powders were produced using the incipient wetting technique with saturated solutions of an iron complex and an iron salt. The iron complex selected was ferrous gluconate, and the salt selected for comparative purposes was ferrous ammonium sulfate. After incipient wetting, each zeolite was dried at 100° C. and then calcined at 550° C. The respective calcined powders each included about 4% iron in the catalyst. Each catalyst was applied as a wash-coat on a cordierite honeycomb, and the SCR activity was measured.

As shown in FIG. 2, the ferrous ammonium sulfate precursor 2 on the β zeolite had faster light-off and a higher conversion rate than the ferrous gluconate precursor 3. Light-off of the ferrous ammonium sulfate at 70% conversion was about 25° C. faster than ferrous gluconate. At about 500° C., the conversion of the ferrous ammonium sulfate precursor began dropping off and by 625° C. was only about 30%. As in Example 1, the ferrous gluconate compound had a relatively constant conversion rate over the temperature range and was still above about 60% at 625° C. Diesel engine exhaust gas is typically above about 500° C., so ferrous gluconate is expected to perform better than ferrous ammonium sulfate in field applications.

### Example 3

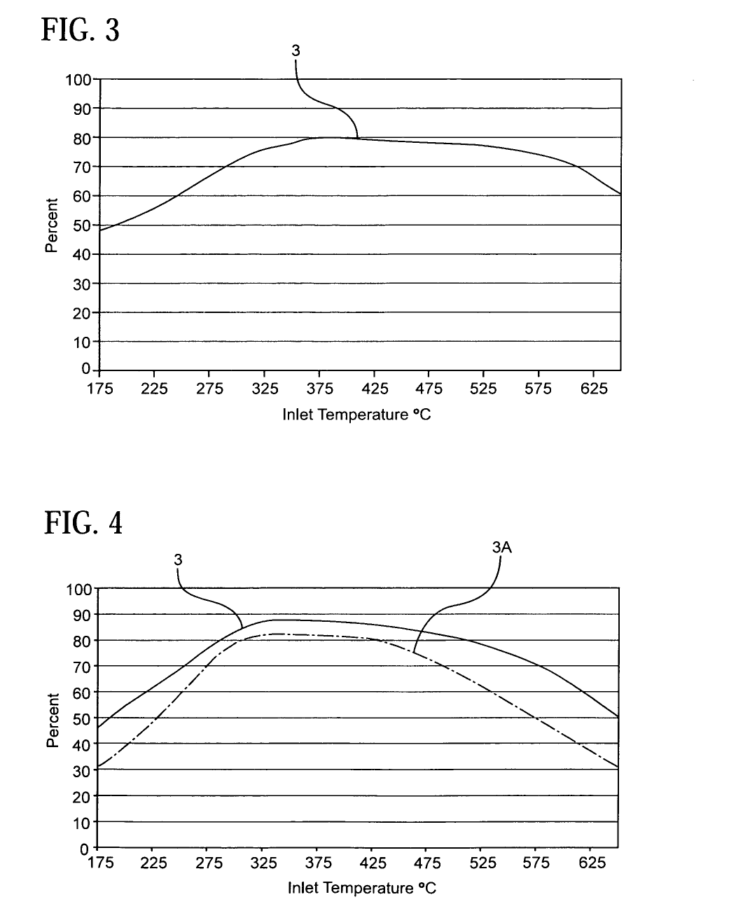

A saturated aqueous solution of ferrous gluconate was prepared. Ferrous gluconate is soluble up to about 10 wt % in water. Lower concentrations could be used but may prolong dry time, calcine time, or both. A 1:1 ratio of the aqueous solution and ZSM-5 zeolite were mixed to form a thin slurry. The actual amount of water may vary depending on the type and particle size of the zeolite. The slurry was spray dried to form an iron-zeolite powder. A mixture was made comprising 40 wt % spray dried iron-zeolite and 60 wt % cordierite. A sufficient amount of binder was included in the mixture to bind the bodies. The binder included methylcellulose as a temporary binder for the green body and an emulsified silicone as a permanent binder for the catalyst body. The mixture was extruded to form a honeycomb green body with a 600/5 cell density. The green body was fired at 850° C. to form a catalyst body. FIG. 3 shows a graph of conversion versus temperature for the catalyst body. The body showed excellent conversion above about 300° C.

### Example 4

Ferrous gluconate can be used successfully on a variety of zeolite materials. For example, two ZSM-5 zeolites having a SiO₂:Al₂O₃ ratio of 50:1 and 300:1 were incipiently wetted in a 1:1 ratio with a 10% aqueous solution of ferrous gluconate. Incipient wetting typically incorporates at least about 40 wt % aqueous solution into the zeolite. The iron-zeolites were then dried at 100° C. and calcined at 500° C. The calcined catalysts included 4 wt % iron. The catalyst was applied as a wash coat to a cordierite honeycomb to form a catalyst body. FIG. 4 shows the conversion percentage of nitrogen oxides from 175-650° C. The zeolite with a 50:1 ratio Fe-zeolite 3 and the 300:1 ratio Fe-zeolite 3A prepared in accord with the disclosure were consistently superior to bodies prepared from the comparative inorganic ferrous or ferric salts.

### Example 5

A slurry was formed comprising 10 parts (by weight) iron gluconate, 100 parts β-zeolite, 90 parts water, and sufficient binder. The slurry was added to a granulated cordierite in a ratio of 40 slurry/60 cordierite to form a mixture. The mixture was extruded to form a honeycomb green body. The green body was dried to remove water and fired to form the catalyst body. Notably, the green body emitted no noxious nitrogen or sulfur containing fumes during drying or firing. The catalyst body converted over 80% of nitrogen oxides over a temperature range from 175-575° C.

The disclosure has been described with reference to various specific embodiments and techniques. However, it should be understood that many variations and modifications are possible while remaining within the spirit and scope of the disclosure. The entire disclosure of publications, patents, and patent documents mentioned herein, if any, are incorporated by reference.

1. A metal-molecular sieve catalyst for use in selective catalytic reduction of nitrogen oxides, the catalyst made by a process comprising:
preparing a mixture of zeolite and a compound of a formula MRₙ where M is a metal having a +2 oxidation state and R is an organic ligand comprising a high electronegativity moiety, and n is an integer from 1 to 4; and
calcining the mixture.

2. The metal-molecular sieve catalyst of claim 1, wherein the process includes drying the mixture before calcining.

3. The metal-molecular sieve catalyst of claim 1, wherein the metal is selected from a group consisting of a transition metal, a lanthanide series metal and combinations thereof.

4. The metal-molecular sieve catalyst of claim 3, wherein the metal includes iron.

5. The metal-molecular sieve catalyst of claim 1, wherein the high electronegativity moiety is selected from a group consisting of a carboxyl, alkoxy, hydroxyl, a halogen and combinations thereof.

6. The metal-molecular sieve catalyst of claim 1, wherein R comprises an anion of a carbohydrate acid.

7. The metal-molecular sieve catalyst of claim 6, wherein the carbohydrate acid includes gluconic acid.

8. A catalyst body for use in selective catalytic reduction of nitrogen oxides, the catalyst body prepared by a process comprising:
preparing a mixture of a molecular sieve and a compound of a formula MRₙ where M is a metal having a +2 oxidation state and R is an organic ligand comprising a high electronegativity moiety, and n is an integer from 1 to 4;
calcining the mixture to form a M-molecular sieve catalyst; and
incorporating the M-molecular sieve catalyst with a refractory honeycomb to form the catalyst body.

9. The catalyst body of claim 8, wherein the M-molecular sieve catalyst is incorporated into the refractory honeycomb as a wash coat.

10. The catalyst body of claim 8, wherein the M-molecular sieve catalyst is incorporated into the refractory honeycomb by forming a mixture of the M-molecular sieve catalyst with a refractory compound, co-extruding the mixture to form a honeycomb green body, and firing the honeycomb green body.

11. The catalyst body of claim 8, wherein the refractory honeycomb includes cordierite.

12. The catalyst body of claim 8, wherein the MRₙ compound comprises ferrous gluconate.

13. A honeycomb article comprising a honeycomb structure including a zeolite and a compound of a formula MRₙ where M is a metal having a +2 oxidation state and R is an organic ligand comprising a high electronegativity moiety, and n is an integer from 1 to 4.

14. The honeycomb article of claim 13, wherein the metal is selected from a group consisting of a transition metal, a lanthanide series metal, and combinations thereof.

15. The honeycomb article of claim 13, wherein the metal includes iron and R comprises an anion of a carbohydrate acid.

16. The honeycomb article of claim 13, wherein the high electronegativity moiety is selected from a group consisting of a carboxyl, alkoxy, hydroxyl, a halogen, and combinations thereof.

17. The honeycomb article of claim 13, wherein the compound of a formula MRₙ comprises ferrous gluconate.

18. The honeycomb article of claim 13, wherein the structure comprises a refractory ceramic.

19. The honeycomb article of claim 19, wherein the refractory ceramic comprises cordierite.

20. A method of preparing a honeycomb catalyst article comprising:
extruding a mixture comprising water, a molecular sieve, a compound of a formula MRₙ where M is a metal having a +2 oxidation state and R is an organic ligand comprising a high electronegativity moiety, and n is an integer from 1 to 4, and a refractory ceramic, to form a honeycomb green body;
optionally drying the green body; and
firing the green body.
